(19) United States
(12) Patent Application Publication
(10) Pub. No.: US 2024/0367526 A1
(43) Pub. Date: Nov. 7, 2024

(54) Driving Force Control Method and Driving Force Control Device

(71) Applicant: Nissan Motor Co., Ltd., Yokohama-shi, Kanagawa (JP)

(72) Inventor: Takashi Ogino, Kanagawa (JP)

(21) Appl. No.: 18/688,988

(22) PCT Filed: Sep. 6, 2021
(86) PCT No.: PCT/JP2021/032723

§ 371 Date: Mar. 4, 2024

(51) Int. Cl. B60L 15/20; B60K 1/02

(52) U.S. Cl. CPC B60L 15/2009; B60K 1/02; B60L 2240/14; B60L 2240/64

(57) ABSTRACT

A driving force control method controls front wheel driving force and rear wheel driving force by a front wheel motor connected to a front wheel of a vehicle and a rear wheel motor connected to a rear wheel, respectively. The driving force control method includes: executing a cooperative process of lifting up or lifting down a vehicle body by cooperation of adjustment of at least one of the front wheel driving force and the rear wheel driving force and application of friction braking force to at least one of the front wheel and the rear wheel.

### TECHNICAL FIELD

The present invention relates to a driving force control method and a driving force control device.

### BACKGROUND ART

In JP 2007-118898 A, there has been proposed a braking and driving force control device that detects a pitch rate (pitch angular velocity) when an in-wheel motor type vehicle passes through a step of a road surface to apply different braking and driving force to front and rear wheels so as to reduce the detected pitch rate (displacement in a pitch direction) when an effect of suspension is not sufficiently achieved in the in-wheel motor type vehicle.

### SUMMARY OF INVENTION

Depending on a traveling scene of the vehicle, there may be a case in which vehicle body displacement (heave vibration) in a vertical direction is mainly large, and control of reducing this is desired. However, in the above-described control of reducing the displacement in the pitch direction by applying the different braking and driving force to the front and rear wheels, there is a problem that an effect of reducing the displacement in the vertical direction is limited.

An object of the present invention is to provide a driving force control method and a driving force control device that can further improve an effect of reducing vertical displacement of a vehicle.

According to an aspect of the invention, provided is that a driving force control method for controlling front wheel driving force and rear wheel driving force by a front wheel motor connected to a front wheel of a vehicle and a rear wheel motor connected to a rear wheel, respectively. The driving force control method includes executing a cooperative process of lifting up or lifting down a vehicle body by cooperation of adjustment of at least one of the front wheel driving force and the rear wheel driving force and application of friction braking force to at least one of the front wheel and the rear wheel.

### BRIEF DESCRIPTION OF DRAWINGS

FIG. 1 is a diagram illustrating a configuration of a vehicle in which a driving force control method according to an embodiment of the present invention is executed.

FIG. 2 is a diagram showing a schematic structure of a chassis system of the vehicle.

FIG. 3 is a diagram illustrating an operation and effect of executing a cooperative process.

FIG. 4 is a flowchart illustrating a driving force control method according to the present embodiment.

FIG. 5 shows timing charts showing examples of time-series changes of control parameters when control according to the present embodiment is executed in an undulation road traveling scene.

FIG. 6 shows diagrams illustrating an operation and effect.

### DESCRIPTION OF EMBODIMENTS

Hereinafter, embodiments of the present invention will be described in detail with reference to the drawings.

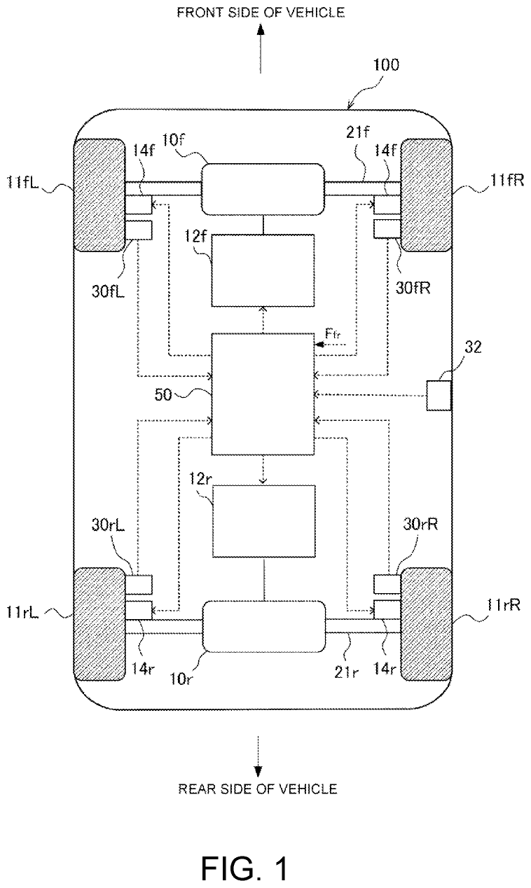

FIG. 1 is a diagram illustrating a configuration of a vehicle 100 in which a driving force control method according to the present embodiment is executed. As the vehicle 100 according to the present embodiment, an electric vehicle, a hybrid vehicle, or the like, which includes a drive motor 10 serving as a driving source and can travel by driving force of the drive motor 10, is assumed.

The drive motor 10 includes a front wheel motor 10f provided at a front position (front wheel side) of the vehicle 100 to drive front wheels 11f, and a rear wheel motor 10r provided at a rear position (rear wheel side) to drive rear wheels 11r.

The front wheel motor 10f is implemented by a three-phase AC motor. During power running, the front wheel motor 10f is supplied with electric power from an in-vehicle battery (not shown) to generate driving force. The driving force generated by the front wheel motor 10f is transmitted to the front wheels 11f via a front wheel transmission 16f and a front wheel drive shaft 21f. On the other hand, during regeneration, the front wheel motor 10f converts regenerative braking force of the front wheels 11f into AC power and supplies the AC power to the in-vehicle battery.

On the other hand, the rear wheel motor 10r is implemented by a three-phase AC motor. During power running, the rear wheel motor 10r is supplied with electric power from the in-vehicle battery to generate driving force. The driving force generated by the rear wheel motor 10r is transmitted to the rear wheels 11r via a rear wheel transmission 16r and a rear wheel drive shaft 21r. During regeneration, the rear wheel motor 10r converts regenerative braking force of the rear wheels 11r into AC power and supplies the AC power to the in-vehicle battery.

An inverter 12 includes a front wheel inverter 12f that adjusts the electric power (positive in the power running and negative in the regeneration) supplied to the front wheel motor 10f, and a rear wheel inverter 12r that adjusts the electric power (positive in the power running and negative in the regeneration) supplied to the rear wheel motor 10r.

The front wheel inverter 12f adjusts the electric power supplied to the front wheel motor 10f such that positive or negative driving force (hereinafter, also referred to as “front wheel driving force F_{f}”) determined for total driving force (hereinafter, also referred to as “total requested driving force F_{fr}”) requested for the vehicle 100 is achieved. On the other hand, the rear wheel inverter 12r adjusts the electric power supplied to the rear wheel motor 10r such that positive or negative driving force (hereinafter, also referred to as “rear wheel driving force Fᵣ”) determined for the total requested driving force F_{fr} is achieved.

In particular, the front wheel driving force F_{f} and the rear wheel driving force Fᵣ in the present embodiment are determined such that a sum thereof matches the total requested driving force F_{fr}. The total requested driving force F_{fr} is determined based on, for example, an operation amount (accelerator opening) for an accelerator pedal mounted on the vehicle 100, or a command from a prescribed autonomous driving system (autonomous driving control device) such as an advanced driver assistance systems (ADAS) or autonomous driving (AD).

A brake actuator 14 is constituted by known mechanical brakes operated by hydraulic pressure or the like, and includes front wheel friction brakes 14f that apply friction braking force (hereinafter also referred to as “front wheel braking force B_{f}”) to the front wheel 11f, and rear wheel friction brakes 14r that apply friction braking force (hereinafter also referred to as “rear wheel braking force Bᵣ”) to the rear wheel 11r.

Further, the vehicle 100 further includes a controller 50 serving as a driving force control device that controls the front wheel driving force F_{f}, the rear wheel driving force Fᵣ, the front wheel braking force B_{f}, and the rear wheel braking force Bᵣ.

The controller 50 is implemented by a computer including a central processing unit (CPU), a read-only memory (ROM), a random access memory (RAM), and an input/output interface (I/O interface), and is programmed so as to execute each processing in vehicle control to be described below. In particular, a function of the controller 50 can be achieved by any in-vehicle computer such as a vehicle control module (VCM), a vehicle motion controller (VMC), and a motor controller, and/or a computer provided outside the vehicle 100. The controller 50 may be implemented by one piece of computer hardware, or may be implemented by distributing various processes by a plurality of pieces of computer hardware.

The controller 50 controls the front wheel driving force F_{f}, the rear wheel driving force Fᵣ, the front wheel braking force B_{f}, and the rear wheel braking force Bᵣ by using the total requested driving force F_{fr}, detection values of vertical acceleration sensors 30fL, 30fR on the front wheel side, detection values of vertical acceleration sensors 30rL, 30rR on the rear wheel side, a suspension stroke amount Sₛᵤ detected by a sensor (not shown), and the like as input information. More specifically, the controller 50 issues a command to the front wheel inverter 12f, the rear wheel inverter 12r, the front wheel friction brake 14f, and the rear wheel friction brake 14r so as to achieve desired front wheel driving force F_{f}, rear wheel driving force Fᵣ, front wheel braking force B_{f}, and rear wheel braking force Bᵣ.

In particular, in the present embodiment, the controller 50 executes any one of basic drive control, a cooperative process, and a non-cooperative process as control that defines driving force distribution during forward traveling (particularly, during acceleration) of the vehicle 100.

The controller 50 executes the basic drive control during normal traveling (in the present embodiment, in particular, a scene other than traveling on an undulation road to be described later). In the basic drive control, the controller 50 sets the front wheel driving force F_{f} and the rear wheel driving force Fᵣ to prescribed basic front wheel driving force and prescribed basic rear wheel driving force, respectively.

Here, the basic front wheel driving force and the basic rear wheel driving force are values determined by experiments, simulations, or the like so that vehicle characteristics (in particular, power consumption performance) of the vehicle 100 take desired characteristics according to a traveling scene. Specific values of the basic front wheel driving force and the basic rear wheel driving force may be appropriately changed in accordance with a specification of the vehicle 100 and the traveling scene. For example, when the vehicle 100 travels straight on a flat paved road at a constant speed, a distribution ratio of the basic front wheel driving force and the basic rear wheel driving force to the total requested driving force F_{fr} can be set to 50:50.

On the other hand, when controller 50 detects a scene in which the vehicle 100 travels on a prescribed undulation road based on various pieces of input information, the controller 50 executes any one of the cooperative process and the non-cooperative process according to a size (amplitude) of an unevenness of the undulation road. In the present embodiment, the undulation road means a traveling road on which an unevenness is present over a certain distance in a traveling direction of the vehicle 100. In the following, in particular, a portion of the undulation road protruding from a flat surface is referred to as a “mountain”, and a portion thereof recessed from the flat surface is referred to as a “valley”.

In the cooperative process, the controller 50 executes either a first control mode or a second control mode in response to a request to lift up a vehicle body or a request to lift down the vehicle body.

In the first control mode, the controller 50 sets the front wheel braking force B_{f} to a positive value, sets the front wheel driving force F_{f} to a negative value, and sets the rear wheel driving force Fr to a positive value. That is, the controller 50 causes the front wheel motor 10f to execute regeneration (causes the front wheels 11f to execute regenerative braking), causes the rear wheel motor 10r to execute power running (causes the rear wheels 11r to execute power driving), and then applies the friction braking force to the front wheels 11f. In the second control mode, the controller 50 sets the front wheel driving force F_{f} to a positive value, sets the rear wheel driving force Fᵣ to a negative value, and sets the rear wheel braking force Bᵣ to a positive value. That is, the controller 50 causes the front wheel motor 10f to execute power running (causes the front wheels 11f to execute power driving), causes the rear wheel motor 10r to execute regeneration (causes the rear wheels 11r to execute regenerative braking), and then applies the friction braking force to the rear wheels 11r.

On the other hand, in the non-cooperative process, the controller 50 executes either a third control mode or a fourth control mode in response to a request to lift up the vehicle body or a request to lift down the vehicle body.

In the third control mode, the controller 50 sets the front wheel driving force F_{f} to a negative value and sets the rear wheel driving force Fᵣ to a positive value without applying the front wheel braking force B_{f}. Further, in the fourth control mode, the controller 50 sets the front wheel driving force F_{f} to a positive value and sets the rear wheel driving force Fᵣ to a negative value without applying the rear wheel braking force Bᵣ.

A relationship between adjustment of the front wheel driving force F_{f}, the rear wheel driving force Fᵣ, the front wheel braking force B_{f}, and the rear wheel braking force Bᵣ and reduction of vertical displacement of the vehicle body in the cooperative process and the non-cooperative process will be described more specifically.

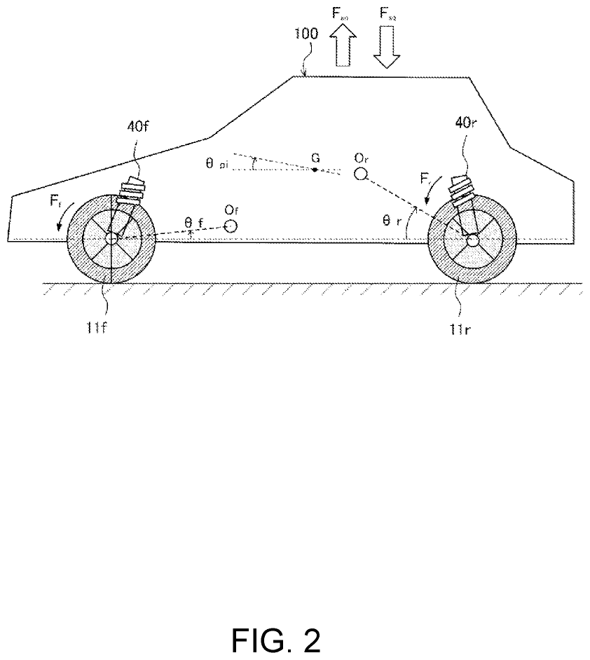

FIG. 2 is a diagram illustrating a schematic structure (particularly, an outline of a suspension geometry) of a chassis system of the vehicle 100. In the figure, “O_{f}” represents a virtual rotation center (instantaneous rotation center) in a pitch direction of a vehicle body front portion, and “Oᵣ” represents a virtual rotation center (instantaneous rotation center) in the pitch direction of a vehicle body rear portion.

When the vehicle 100 is traveling forward, when the regenerative braking force (force in a direction opposite to the traveling direction) is applied to the front wheels 11f and power driving force (force in the same direction as the traveling direction) is applied to the rear wheels 11r, anti-squat force Fₐₙ (force for lifting the vehicle body) acts on the vehicle body. On the other hand, when power driving force is applied to the front wheels 11f and regenerative braking force is applied to the rear wheels 11r, squat force F_{sq} (force for causing the vehicle body to sink) acts on the vehicle body.

Accordingly, theoretically, in the scene in which the vehicle 100 travels on the undulation road or the like, by performing pitch adjustment (that is, the above-described non-cooperative process) by adjusting the driving force distribution of the front wheels 11f and the rear wheels 11r, it is possible to reduce the vertical displacement (heave vibration) of the vehicle body by appropriately lifting up or lifting down the vehicle body.

On the other hand, a magnitude of the anti-squat force Fₐₙ or the squat force F_{sq} obtained by the non-cooperative process depends on a magnitude of an anti-squat angle θ (front anti-squat angle θ_{f} and rear anti-squat angle θᵣ) of a suspension 40 (front suspension 40f and rear suspension 40r) of the vehicle 100.

More specifically, the front wheel driving force F_{f} generated by the front wheel motor 10f and the rear wheel driving force Fᵣ generated by the rear wheel motor 10r are transmitted to the front wheels 11f and the rear wheels 11r, respectively, with the front wheel drive shaft 21 and the rear wheel drive shaft 21r as working points.

Therefore, the anti-squat angles θ_{f} and θᵣ, which define a vertical component of pitching force generated by the adjustment of the driving force distribution (that is, the magnitude of the anti-squat force Fₐₙ or the squat force F_{sq}), are respectively determined as angles formed by a horizontal line and straight lines respectively connecting the virtual rotation centers O_{f} and Oᵣ determined by structures of the suspensions 40f, 40r and the working points.

Therefore, in a case in which the anti-squat angles θ_{f} and θᵣ cannot be increased (in a case in which the virtual rotation centers O_{f} and Oᵣ are located at relatively low positions) due to the structures of the suspensions 40f and 40r, a range of the anti-squat force Fan or the squat force F_{sq} obtained by adjusting the driving force distribution is limited.

In particular, as in the vehicle 100 of the present embodiment shown in FIG. 2, in a case in which a suspension structure in which the front anti-squat angle Of is relatively small is adopted in consideration of ride comfort and nose dive feeling during braking, there is a problem that a sufficient effect of reducing the vertical displacement of the vehicle body cannot be achieved even if the non-cooperative process is executed.

In contrast, the present inventor has found that a high effect of reducing the vertical displacement of the vehicle body can be achieved even in the vehicle 100 equipped with the suspension structure having a relatively small anti-squat angle θ by adjusting net driving force distribution applied to the front wheels 11f and the rear wheels 11r beyond an adjustment range by the non-cooperative process using the front wheel braking force B_{f} or the rear wheel braking force Bᵣ.

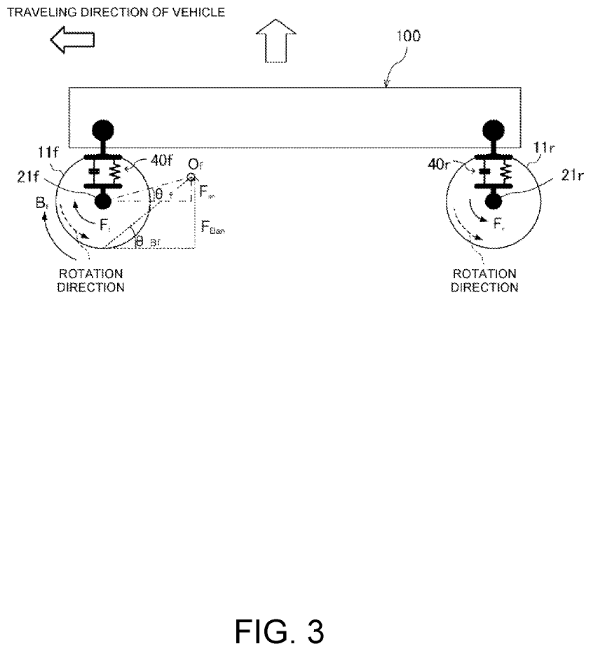

FIG. 3 is a diagram illustrating an operation and effect of executing the cooperative process. In the following description, in particular, the operation and effect of the cooperative process will be described focusing on the first control mode (application of the front wheel braking force B_{f}, regenerative braking of the front wheels 11f, and power driving of the rear wheels 11r). On the other hand, the following description also applies to the second control mode (power driving of the front wheels 11f, application of the rear wheel braking force Bᵣ, and regenerative braking of the rear wheels 11r).

As shown in the figure, when the first control mode is executed while the vehicle 100 is traveling forward, a working point of the front wheel braking force B_{f} is an outer peripheral portion of the front wheel 11f. Therefore, an anti-squat angle θ_{Br} determined as an angle formed by a horizontal line and a straight line that connects the virtual rotation center O_{f} on the front wheel side and the working point of the front wheel braking force B_{f} to each other is larger than the anti-squat angle θ_{f} in the non-cooperative process. Therefore, when the first control mode of the cooperative process is executed, the effect of reducing the vertical displacement of the vehicle body can be further enhanced compared to when the third control mode of the non-cooperative process is executed.

On the other hand, the cooperative process is control of operating the mechanical brake actuator 14. Therefore, in terms of control responsiveness, the non-cooperative process, which is electrical control without operation of a mechanical actuator, is superior.

Hereinafter, an example will be described in which, in a scene in which the vehicle 100 travels on an undulation road, a situation in which the reduction of the vertical displacement of the vehicle body is prioritized and a situation in which the control responsiveness is prioritized are distinguished according to the size of an unevenness of a traveling road surface, and one of the cooperative process and the non-cooperative process is appropriately executed.

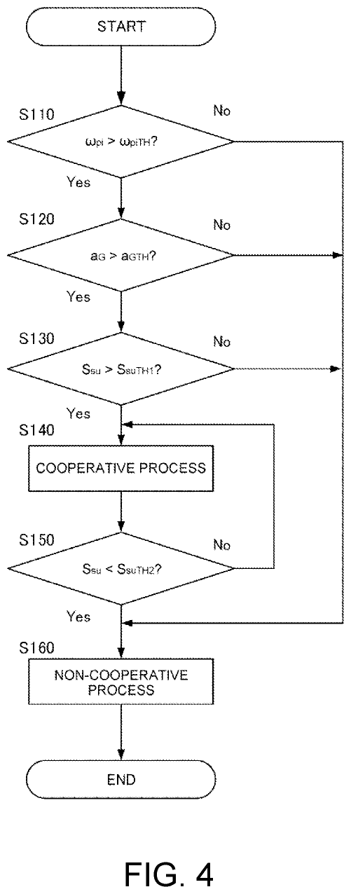

FIG. 4 is a flowchart illustrating the driving force control method according to the present embodiment. Each process shown in FIG. 4 is executed based on a timing at which the controller 50 determines that the vehicle 100 is traveling on the undulation road based on information of a traveling road provided from a prescribed internal sensor or an external server mounted on the vehicle 100. In particular, the controller 50 repeatedly executes each process shown in FIG. 4 at prescribed calculation intervals in the scene.

In steps S110 and S120, the controller 50 determines whether a pitch rate ωₚᵢ and vertical acceleration a_{G} exceed a pitch rate threshold value ω_{piTH} and a vertical acceleration threshold value a_{GTH}, respectively.

Here, the pitch rate ωₚᵢ is a parameter defined as a time derivative (that is, a pitch angular velocity) of a pitch angle θₚᵢ. Further, the pitch angle θₚᵢ is determined as a displacement angle in the pitch direction with respect to a horizontal direction around a center of gravity G of the vehicle 100 (see FIG. 2). A sign of the pitch angle θₚᵢ is set such that a direction in which the front wheel 11f of the vehicle 100 is lifted up (nose up direction) is positive and a direction in which the rear wheel 11r is lifted up (nose down direction) is negative. Further, the vertical acceleration a_{G} is acceleration in the vertical displacement of the vehicle 100 (center of gravity G of the vehicle 100). The pitch rate ωₚᵢ, the pitch angle θₚᵢ, and the vertical acceleration a_{G} can be calculated by a known method based on the detection values of the vertical acceleration sensors 30fL, 30fR on the front wheel side, the detection values of the vertical acceleration sensors 30rL, 30rR on the rear wheel side, and other necessary parameters.

Both the pitch rate ωₚᵢ and the vertical acceleration a_{G} are parameters representing magnitude of the actual vertical displacement of the vehicle 100 during traveling on the undulation road. That is, both the pitch rate ωₚᵢ and the vertical acceleration ac are parameters (unevenness degree parameters) indicating the size of the unevenness of the undulation road.

Further, the pitch rate threshold value ω_{piTH} and the vertical acceleration threshold value a_{GTH} are determined as values to appropriately determine which of the effect of reducing the vertical displacement of the vehicle 100 and the high control responsiveness is prioritized. More specifically, the pitch rate threshold value ω_{piTH} and the vertical acceleration threshold value a_{GTH} are determined so that the cooperative process is executed when the unevenness of the undulation road is relatively large (when the high control responsiveness is not required, but the high effect of reducing the vertical displacement is required). Conversely, the pitch rate threshold value ω_{piTH} and the vertical acceleration threshold value a_{GTH} are determined such that the non-cooperative process is executed when the unevenness of the undulation road is relatively small (when the high control responsiveness is required, but the required effect of reducing the vertical displacement is small).

Further, the controller 50 executes a process of step S130 when both determination results of step S110 and step S120 are positive, and otherwise executes the non-cooperative process (step S160).

In step S130, the controller 50 determines whether the suspension stroke amount Sₛᵤ exceeds a first stroke amount threshold value S_{suTH1}.

Similarly to the pitch rate ωₚᵢ the vertical acceleration a_{G}, the suspension stroke amount Sₛᵤ is also an unevenness degree parameter representing the magnitude of the actual vertical displacement of the vehicle 100 during traveling on the undulation road. Further, the first stroke amount threshold value S_{suTH1} is also set to a suitable value from the viewpoint of determining whether the unevenness of the undulation road is large to an extent that the reduction of the vertical displacement of the vehicle 100 by the cooperative process using the front wheel braking force B_{f} or the rear wheel braking force Bᵣ is desired.

Further, when a determination result of step S130 is positive, the controller 50 executes the cooperative process (step S140), and otherwise, executes the non-cooperative process (step S160).

As a specific example of the cooperative process, the controller 50 executes the first control mode (lifts up the vehicle body) so as to cancel force in a lift down direction in a scene in which the vehicle 100 is traveling on a valley portion of the undulation road and the force in the lift down direction is generated on the vehicle body. On the other hand, the controller 50 executes the second control mode (lifts down the vehicle body) so as to cancel force in a lift up direction in a scene in which the vehicle 100 is traveling on the mountain of the undulation road and the force in the lift up direction is generated on the vehicle body.

Further, as an example of the non-cooperative process, the controller 50 executes the third control mode (lifts up the vehicle body) so as to cancel force in the lift down direction in a scene in which the vehicle 100 travels on the valley portion of the undulation road and the force in the lift down direction is generated on the vehicle body. On the other hand, the controller 50 executes the fourth control mode (lifts down the vehicle body) so as to cancel force in the lift up direction in a scene in which the vehicle 100 is traveling on the mountain of the undulation road and the force in the lift up direction is generated on the vehicle body.

An aspect of selection of the first control mode or the second control mode in the cooperative process and an aspect of selection of the third control mode or the fourth control mode in the non-cooperative process described above are examples, and the present invention is not limited thereto. Specific values of the front wheel driving force F_{f}, the rear wheel driving force Fᵣ, the front wheel braking force B_{f}, and the rear wheel braking force Bᵣ set in the cooperative process or the non-cooperative process are not limited to specific values, and can be appropriately adjusted according to a situation.

Further, the controller 50 determines whether the suspension stroke amount Sₛᵤ falls below a second stroke amount threshold value S_{suTH2} during the execution of the cooperative process (step S150).

The second stroke amount threshold value S_{suTH2} is set to an appropriate value from the viewpoint of determining whether the unevenness of the undulation road is small enough to determine that it is necessary to switch from the cooperative process to the non-cooperative process in consideration of the control responsiveness.

Further, when the controller 50 determines that the suspension stroke amount Sₛᵤ falls below the second stroke amount threshold value S_{suTH2}, the controller 50 switches the control from the cooperative process to the non-cooperative process (step S160) and ends this routine.

In consideration of low control responsiveness in the above-described cooperative process, a configuration may be adopted in which the switching from the cooperative process to the non-cooperative process is executed when the suspension stroke amount Sₛᵤ falls below the second stroke amount threshold value S_{suTH2} a plurality of times. In particular, it takes a certain amount of time until the effect of reducing the vertical displacement of the vehicle body is actually obtained after the cooperative process is started according to the determination result of step S130. In consideration of this, it is possible to prevent a situation where a state in which the suspension stroke amount Sₛᵤ is temporarily decreased is detected and the control is switched to the non-cooperative process even though the front wheel braking force B_{fr} or the rear wheel braking force Bᵣ has not yet followed the command immediately after a start of the cooperative process or the like. Further, in determination of step S150 (determination of whether to switch from the cooperative process to the non-cooperative process), a configuration may be adopted in which the pitch rate ωₚᵢ and/or the vertical acceleration a_{G} are appropriately compared with the threshold values.

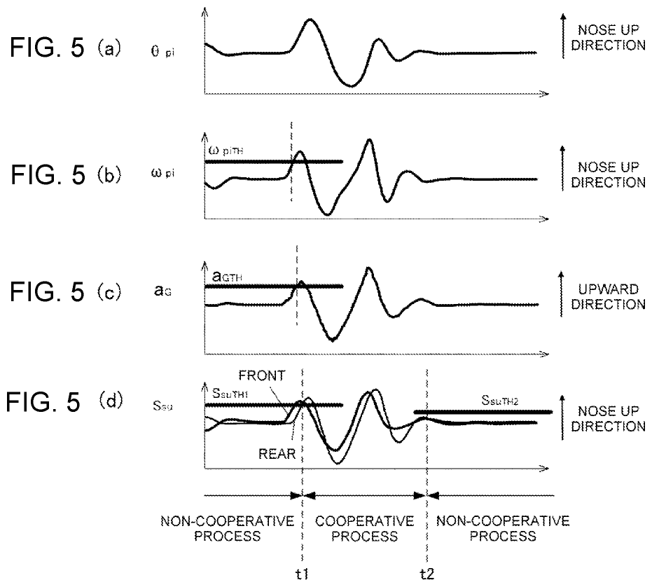

FIG. 5 shows timing charts showing examples of time-series changes of control parameters when the control according to the present embodiment is executed in an undulation road traveling scene. In the timing charts of FIG. 5, the pitch angle θₚᵢ and the pitch rate ωₚᵢ are positive in the nose up direction of the vehicle 100, the vertical acceleration ac is positive in an upward direction with respect to the vehicle 100, and the suspension stroke amount Sₛᵤ is positive in a compression direction of the suspension 40.

As shown in the drawing, in a section (time t<t1) in which any one of the pitch rate ωₚᵢ, the vertical acceleration a_{G}, and the suspension stroke amount Sₛᵤ is equal to or less than a respective one of the threshold values, that is, in a scene in which the unevenness of the undulation road is estimated to be relatively small, the non-cooperative process is executed with priority given to the control responsiveness.

Further, when all of the pitch rate ωₚᵢ, the vertical acceleration a_{G}, and the suspension stroke amount Sₛᵤ (particularly, in FIG. 5, the suspension stroke amount Sₛᵤ on the rear wheel side) exceed the respective threshold values (time t=t1), that is, when the vehicle 100 is estimated to enter a section in which the unevenness of the undulation road is relatively large, the control is switched from the non-cooperative process to the cooperative process from the viewpoint of improving the effect of reducing the vertical displacement of the vehicle body.

Thereafter, when the suspension stroke amount Sₛᵤ (in FIG. 5, the suspension stroke amount Sₛᵤ on both the front wheel side and the rear wheel side) falls below the second stroke amount threshold value S_{suTH2}, that is, when the vehicle 100 is estimated to enter a section in which the unevenness of the undulation road is relatively small, the control is switched from the cooperative process to the non-cooperative process again.

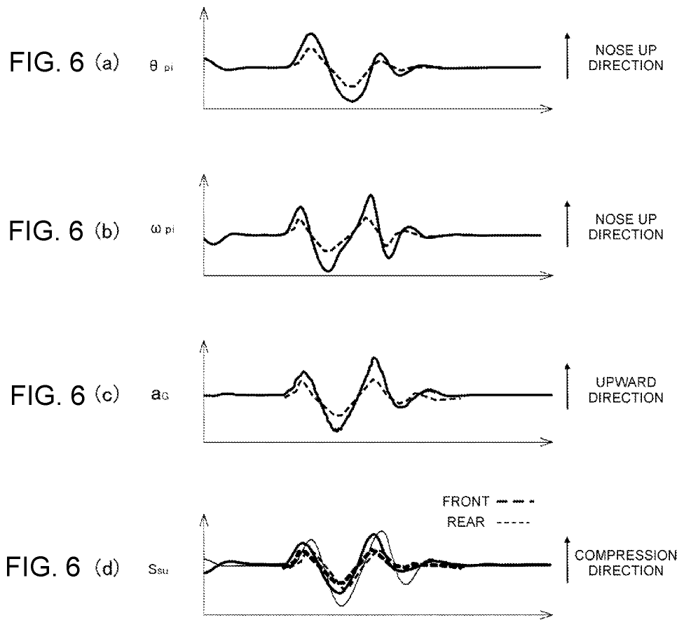

FIG. 6 shows diagrams illustrating an operation and effect of executing the control described in the timing charts of FIG. 5. As shown in the figure, the pitch rate ωₚᵢ, the vertical acceleration a_{G}, and the suspension stroke amount Sₛᵤ (see broken lines), which are parameters indicating the magnitude of the vertical displacement in the control according to the present embodiment, are reduced compared to those (see solid lines) in a comparative example in which the basic drive control is maintained even during traveling on the undulation road.

Hereinafter, a configuration of the above-described present embodiment and an operation and effect thereof will be collectively described.

The present embodiment provides the driving force control method for controlling the front wheel driving force Fᵣ and the rear wheel driving force Fᵣ by the front wheel motor 10f connected to the front wheels 11f of the vehicle 100 and the rear wheel motor 10r connected to the rear wheels 11r, respectively.

In this driving force control method, the cooperative process (step S140) is executed in which the adjustment of at least one of the front wheel driving force F_{f} and the rear wheel driving force Fᵣ and the application of the friction braking force (front wheel braking force B_{f} or rear wheel braking force Bᵣ) to at least one of the front wheel 11f and the rear wheel 11r cooperate to lift up or lift down the vehicle body.

Accordingly, it is possible to further improve the effect of reducing the vertical displacement (heave vibration) of the vehicle 100 compared to the case in which the vehicle body is lifted up or lifted down by control of adjusting only the front wheel driving force F_{f} and the rear wheel driving force Fᵣ.

In particular, the cooperative process (step S140) includes the first control mode in which the vehicle body is lifted up and the second control mode in which the vehicle body is lifted down. Further, in the first control mode, the friction braking force (front wheel braking force B_{f}) is applied to the front wheels 11f to power the rear wheel motor 10r. In the second control mode, the front wheel motor 10f is powered and the friction braking force (rear wheel braking force Bᵣ) is applied to the rear wheel 11r.

Accordingly, when the vehicle 100 travels forward, a more specific control mode for lifting up or lifting down the vehicle body is achieved in the cooperative process.

The driving force control method according to the present embodiment further executes the non-cooperative process of lifting up or lifting down the vehicle body only by adjusting the front wheel driving force Fᵣ and the rear wheel driving force Fᵣ (step S160). Further, the non-cooperative process includes the third control mode in which the front wheel motor 10f is regenerated and the rear wheel motor 10r is powered, and the fourth control mode in which the front wheel motor 10f is powered and the rear wheel 11r is regenerated.

Accordingly, in accordance with the traveling scene of the vehicle 100 or the like, it is possible to execute the lifting up or the lifting down of the vehicle body by the non-cooperative process having the high control responsiveness instead of the cooperative process as appropriate. In this description, the term “only by the adjustment of the front wheel driving force F_{f} and the rear wheel driving force Fᵣ” means that the operation amount for the control of lifting up or lifting down the vehicle body includes the front wheel driving force F_{f} and the rear wheel driving force Fᵣ, but does not include the friction braking force. Therefore, the above term is not intended to exclude from the technical scope of the present invention a form in which control logic that uses an operation amount other than the friction braking force to assist in lifting up or lifting down the vehicle body is included in the non-cooperative process.

Furthermore, in the driving force control method according to the present embodiment, when the vehicle 100 is traveling on the undulation road, the unevenness degree parameters (pitch rate ωₚᵢ, vertical acceleration ac, and suspension stroke amount Sₛᵤ) indicating the size of the unevenness of the undulation road are obtained. Further, when the unevenness degree parameters exceed respective prescribed first threshold values (pitch rate threshold value ω_{piTH}, vertical acceleration threshold value a_{GTH}, and/or first stroke amount threshold value S_{suTH1}) during the execution of the non-cooperative process, the non-cooperative process is switched to the cooperative process (steps S110 to S130 and S140).

Accordingly, it is possible to appropriately select the cooperative process having the effect of reducing the vertical displacement and the non-cooperative process in which the control responsiveness is high according to the size of the unevenness in the undulation road traveled by the vehicle 100.

In particular, in the present embodiment, when the unevenness degree parameter (particularly, the suspension stroke amount Sₛᵤ) falls below a prescribed second threshold value (second stroke amount threshold value S_{suTH2}) during the execution of the cooperative process, the cooperative process is switched to the non-cooperative process.

Accordingly, it is possible to more appropriately select the cooperative process having the effect of reducing the vertical displacement and the non-cooperative process in which the control responsiveness is high according to the size of the unevenness in the undulation road traveled by the vehicle 100.

Further, in the present embodiment, the controller 50 that functions as the driving force control device that executes the driving force control method is provided. The controller 50 controls the front wheel driving force Fᵣ and the rear wheel driving force Fᵣ by the front wheel motor 10f connected to the front wheels 11f of the vehicle 100 and the rear wheel motor 10r connected to the rear wheels 11r, respectively.

In particular, the controller 50 includes a cooperative process unit (step S140) that causes the adjustment of the at least one of the front wheel driving force F_{f} and the rear wheel driving force Fᵣ to cooperate with the application of the friction braking force (front wheel braking force B_{f} or rear wheel braking force Bᵣ) to the at least one of the front wheel 11f and the rear wheel 11r to lift up or lift down the vehicle body.

Accordingly, a configuration of the control device suitable for executing the driving force control method is achieved.

Although the embodiment of the present invention has been described above, the above embodiment is merely a part of application examples of the present invention, and does not intend to limit the technical scope of the present invention to the specific configurations of the above embodiment.

For example, in the above embodiment, the example has been described in which one of the non-cooperative process and the cooperative process is executed according to the size of the unevenness in the scene in which the vehicle 100 is traveling on the undulation road. However, the present invention is not limited thereto, and the same control can be executed in other traveling scenes in which the vertical displacement of the vehicle 100 is assumed to be reduced.

Furthermore, a specific aspect of the unevenness degree parameter is not limited to that described in the above embodiment. For example, information related to the unevenness of the undulation road may be acquired using a Lidar camera and/or any in-vehicle sensor such as a radar, and a value obtained by directly estimating the size of the unevenness from the information may be used as the unevenness degree parameter. Furthermore, parameters used for determining the switching from the non-cooperative process to the cooperative process are not limited to the unevenness degree parameters described above. For example, a configuration may be adopted in which a parameter indicating a length of a period of the mountain and valley of the unevenness of the undulation road is acquired based on information acquired from an in-vehicle server or an external server, and it is determined whether to switch from the non-cooperative process to the cooperative process based on the parameter.

In the above-described embodiment, the example has been described in which the adjustment (pitch adjustment) of the driving force distribution and the application of the friction braking force to the respective driving wheels cooperate with each other in both the first control mode (lift up control) and the second control mode (lift down control) of the cooperative process. However, the present invention is not limited thereto, and in the cooperative process, a control mode may be adopted in which the friction braking force is applied to only one of the first control mode and the second control mode. For example, a control mode may be adopted in which the front wheel braking force B_{f} is applied in the first control mode (lift up control) of the cooperative process, but the rear wheel braking force Bᵣ is not applied in the second control mode (lift down control). As shown in FIG. 2, it is particularly preferable that the control logic is applied to a vehicle body structure in which, while the anti-squat angle Of on the front side is relatively small, the anti-squat angle Or on the rear side is relatively large, and a sufficient lift up and down amount can be ensured only by adjusting the driving force distribution on the rear side.

Further, in the above-described embodiment, the example has been described in which the control mode in which pitch displacement is adjusted by adjusting only the driving force distribution of the vehicle 100 is adopted as the non-cooperative process. However, instead of this, it is also possible to adopt a control mode in which the non-cooperative process is any driving force distribution (for example, the basic drive control that determines the driving force distribution during normal traveling) executed for purposes other than the purpose of adjusting the pitch displacement. For example, the technical scope of the present invention also includes a control mode in which the non-cooperative process is used as the basic drive control to achieve direct switching between the basic drive control and the cooperative process (switching without intervention of the pitch adjustment performed by the adjustment of the driving force distribution) as appropriate according to a situation of the traveling road surface such as the size of the unevenness of the undulation road.

1. A driving force control method for controlling front wheel driving force and rear wheel driving force by a front wheel motor connected to a front wheel of a vehicle and a rear wheel motor connected to a rear wheel, respectively, the driving force control method comprising:
acquiring a pitch rate, vertical acceleration, and a suspension stroke amount of the vehicle as an unevenness degree parameter indicating vertical displacement of the vehicle according to a size of an unevenness of a road surface on which the vehicle travels;
determining a level of a request for reducing the vertical displacement with reference to the unevenness degree parameter; and
switching between and executing a cooperative process and a non-cooperative process according to a determination result of the level of the request, wherein
in the cooperative process, a vehicle body is lifted up or lifted down-by cooperation of adjustment of at least one of the front wheel driving force and the rear wheel driving force and application of friction braking force to at least one of the front wheel and the rear wheel, and
in the non-cooperative process, the vehicle body is lifted up or lifted down only by adjusting the front wheel driving force and the rear wheel driving force.

2. The driving force control method according to claim 1, wherein
the cooperative process includes a first control mode in which the vehicle body is lifted up and a second control mode in which the vehicle body is lifted down,
in the first control mode, the friction braking force is applied to the front wheel to power the rear wheel motor, and
in the second control mode, the front wheel motor is powered, and the friction braking force is applied to the rear wheel or the rear wheel is regenerated.

3. The driving force control method according to claim 1, wherein the non-cooperative process includes a third control mode in which the front wheel motor is regenerated and the rear wheel motor is powered, and a fourth control mode in which the front wheel motor is powered and the rear wheel motor is regenerated.

4. The driving force control method according to claim 3, further comprising:
when the vehicle is traveling on an undulation road, acquiring the unevenness degree parameter, wherein
during execution of the non-cooperative process, the non-cooperative process is switched to the cooperative process when the unevenness degree parameter exceeds a prescribed first threshold value.

5. The driving force control method according to claim 4, wherein during execution of the cooperative process, the cooperative process is switched to the non-cooperative process when the unevenness degree parameter falls below a prescribed second threshold value.

6. A driving force control device that controls front wheel driving force and rear wheel driving force by a front wheel motor connected to a front wheel of a vehicle and a rear wheel motor connected to a rear wheel, respectively, the driving force control device being configured to:
acquire a pitch rate, vertical acceleration, and a suspension stroke amount of the vehicle as an unevenness degree parameter indicating vertical displacement of the vehicle according to a size of an unevenness of a road surface on which the vehicle travels;
determine a level of a request for reducing the vertical displacement with reference to the unevenness degree parameter; and
switch between and execute a cooperative process and a non-cooperative process according to a determination result of the level of the request, wherein
in the cooperative process, a vehicle body is lifted up or lifted down by cooperation of adjustment of at least one of the front wheel driving force and the rear wheel driving force and application of friction braking force to at least one of the front wheel and the rear wheel, and
in the non-cooperative process, the vehicle body is lifted up or lifted down only by adjusting the front wheel driving force and the rear wheel driving force.
